(19) United States
(12) Patent Application Publication
(10) Pub. No.: US 2004/0074343 A1
(43) Pub. Date: Apr. 22, 2004

(54) Ratchet wrench

(76) Inventor: Chih-Ching Hsieh, Taipei (TW)

Correspondence Address: Chih-Ching Hsieh, 235 Chung-Ho, Box 8-24, Taipei, TW

(21) Appl. No.: 10/273,056

(22) Filed: Oct. 18, 2002

(51) Int. Cl. B25B 13/46

(52) U.S. Cl. 81/63.2

(57) ABSTRACT

A ratchet wrench using a sliding stop rod to control the direction of rotation of the ratchet wheel, the sliding stop rod has a smoothly arched front actuating face curved inwards in a rectangular front side thereof, and two toothed portions bilaterally formed in the smoothly arched front actuating face and adapted for engaging the ratchet wheel, the toothed portions having an equal width.

### BACKGROUND OF THE INVENTION

The present invention relates to ratchet wrenches, and more specifically, to such a ratchet wrench, which enhances the torsional force and, is durable in use.

FIGS. 1 and 2 show a ratchet wrench according to the prior art. This structure of ratchet wrench comprises a handle having a box at one end, a ratchet wheel mounted in the box, a stop rod slidably mounted in a transverse through hole in the connection area between the box and the handle, the stop rod having two toothed portions bilaterally disposed at the front side thereof and two recessed portions disposed at the back side thereof, a spring member mounted in an inside hole inside the handle in communication with the transverse through hole, and a steel ball supported on the spring member and forced into engagement with one recessed portion of the stop rod. The toothed portions of the stop rod, as shown in FIGS. 3 and 4, are formed in a respective sloping face at the front side of the stop rod. The sloping face has a width gradually reduced from the lower inner side toward the upper outer side. This design affects the transmission of torsional force from the handle to the ratchet wheel. Further, the front middle area of the stop rod between the toothed portion is a flat surface, which has two ends respectively perpendicularly connected to the toothed portions. This design tends to cause concentration of stress during fabrication of the ratchet wrench, and the stop rod tends to be deformed during the operation of the ratchet wrench.

### SUMMARY OF THE INVENTION

The present invention has been accomplished to provide a ratchet wrench, which eliminates the aforesaid problem. It is one object of the present invention to provide a ratchet wrench, which is durable in use. It is another object of the present invention to provide a ratchet wrench, which enhances the torsional force from the handle. According to the present invention, the stop rod, which is supported on a steel ball at a spring member inside the wrench body of the ratchet wrench for controlling the direction of rotation of the ratchet wheel, has a smoothly arched front actuating face curved inwards in a rectangular front side thereof, and two toothed portions bilaterally formed in the smoothly arched front actuating face and adapted for engaging the ratchet wheel. The formation of the smoothly arched front actuating face in the rectangular front side of the stop rod prevents concentration of stress. The toothed portions have an equal width for positive transmission of torsional force from the wrench body to the ratchet wheel.

### BRIEF DESCRIPTION OF THE DRAWINGS

FIG. 1 is an exploded view of a ratchet wrench according to the present invention.

FIG. 2 is a sectional assembly view of the ratchet wrench according to the present invention.

FIG. 3 is an elevational view of a stop rod for ratchet wrench according to the prior art.

FIG. 4 is an elevational view of another structure of stop rod for ratchet wrench according to the prior art.

FIG. 5 is a sectional view showing the engagement between the stop rod of FIG. 3 and the ratchet wheel according to the prior art.

FIG. 6 is a sectional view showing the engagement between the strop rod of FIG. 4 and the ratchet wheel of the prior art.

FIG. 7 is an exploded view of a ratchet wrench according to the present invention

FIG. 8 is an elevational view of the stop rod for the ratchet wrench according to the present invention.

FIG. 9 is a sectional view showing the stop rod engaged with the ratchet wheel according to the present invention.

FIG. 10 is an elevational view of an alternate form of the stop rod for the ratchet wrench according to the present invention.

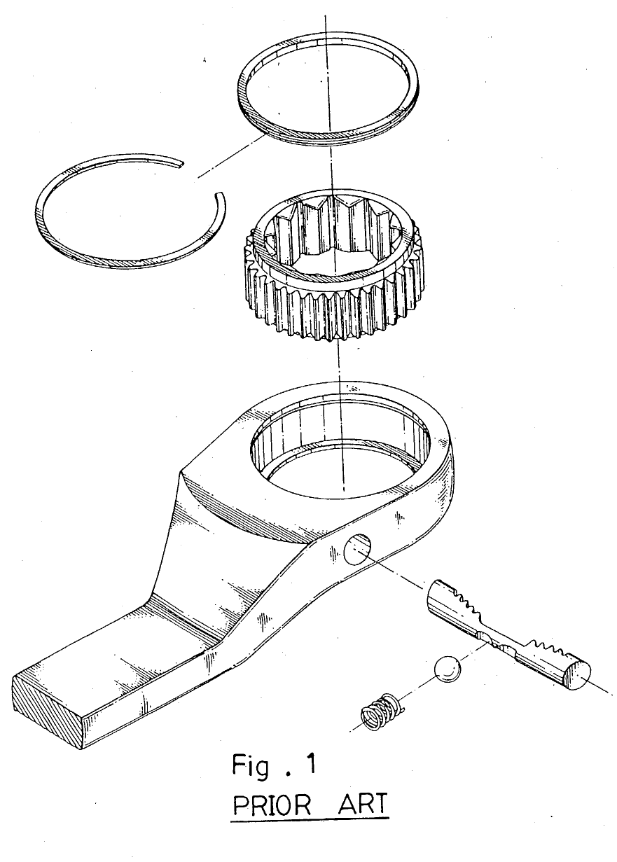

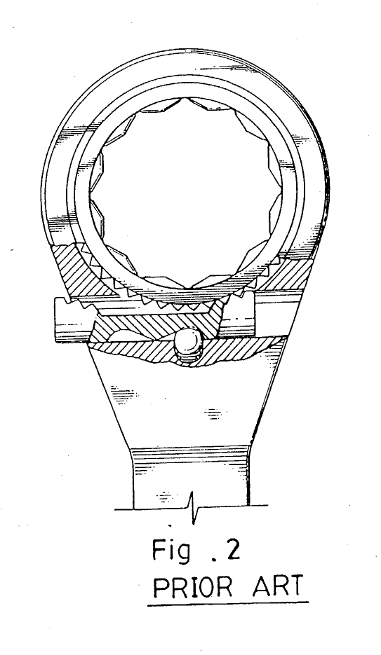

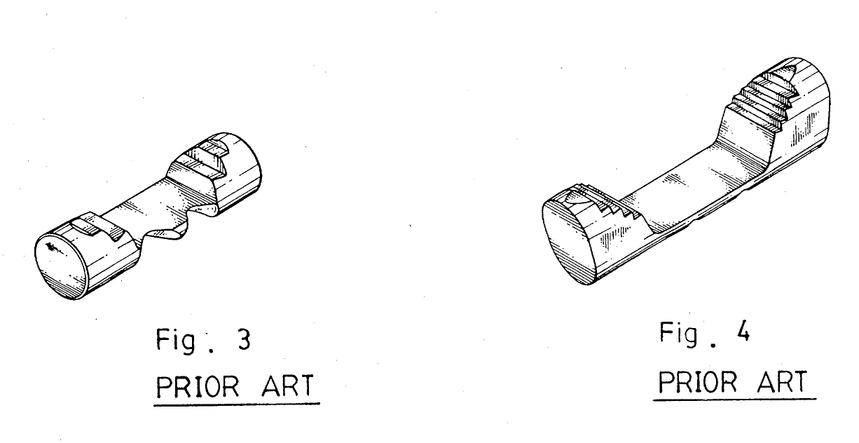

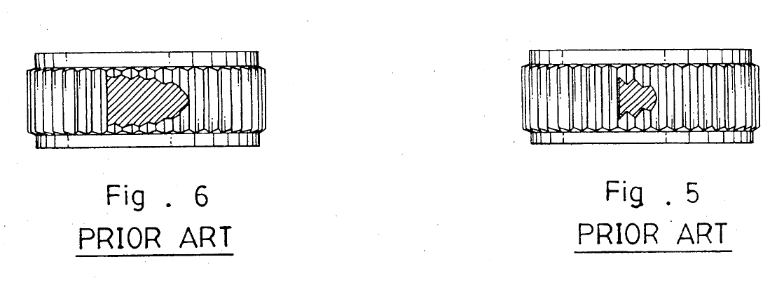

### DETAILED DESCRIPTION OF THE PREFERRED EMBODIMENT

Referring to FIGS. from 7 through 9, a ratchet wrench in accordance with the present invention is shown comprised of a wrench body 10, a ratchet wheel 20, a stop rod 30, a steel ball 41, and a spring member 42.

The wrench body 10 has a circular box 11 defining a circular receiving open chamber 12 adapted for receiving the ratchet wheel 20, a transverse through hole 13 extended through two opposite lateral sidewalls thereof in tangent to the circular receiving open chamber 12 and adapted for receiving the stop rod 30, and an inside blind hole 14 (not shown) perpendicularly backwardly extended from the transverse through hole 13 and adapted for receiving the spring member 42 and the steel ball 41.

The ratchet wheel 20 is an annular gear comprising a series of peripheral teeth 21 arranged around the periphery and sloping in one direction for engagement with the stop rod 30, and a serrated inside wall 22 adapted for holding the workpiece (bolt or nut).

The stop rod 30 is mounted in the transverse through hole 13 of the wrench body 10 and supported on the steel ball 41 at the spring member 42, having a smoothly arched front actuation face 32 and two toothed portions 31 bilaterally disposed in the smoothly arched front actuation face 32. Because the toothed portions 31 are bilaterally formed in the smoothly arched front actuation face 32, they have an equal width, preventing concentration of stress, and enhancing the strength of the stop rod 30.

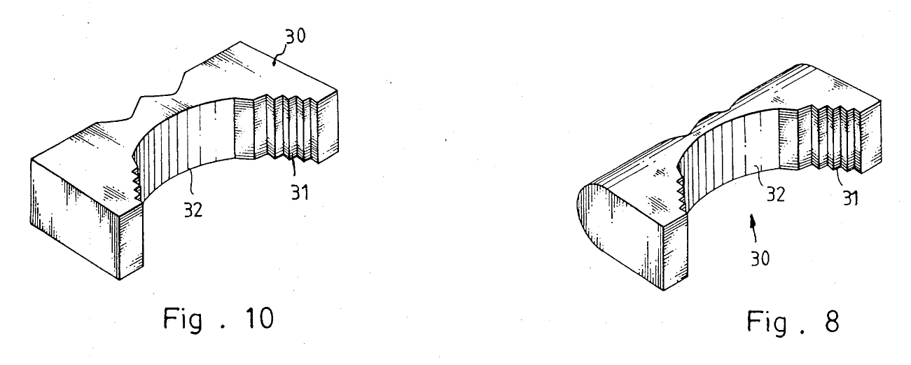

Referring to FIG. 8, the stop rod 30 has a substantially U-shaped cross section, and the smoothly arched front actuating face 32 is formed in the rectangular front side of the stop rod 30.

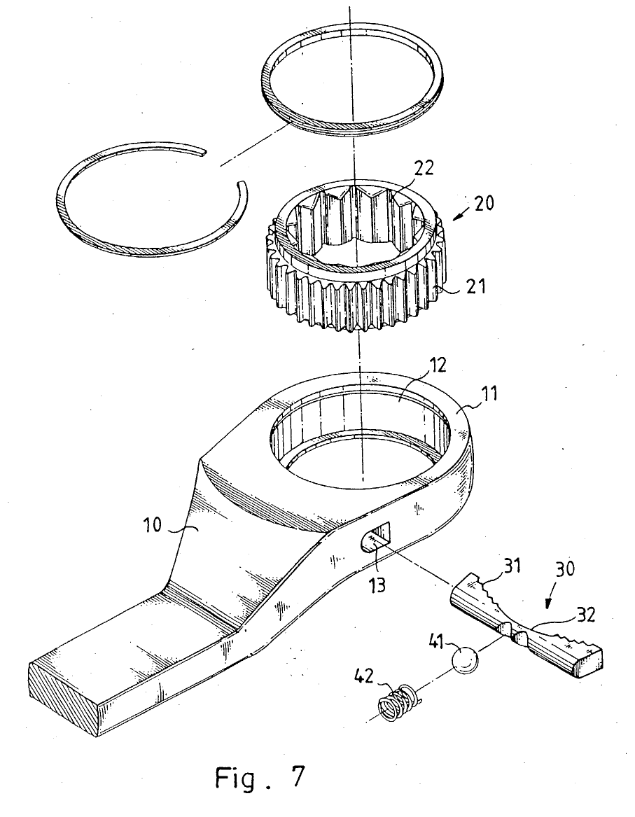

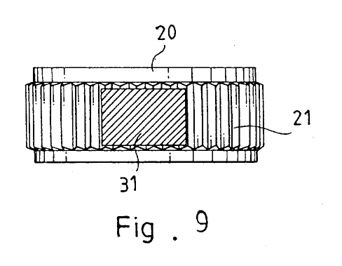

Referring to FIG. 9 and FIG. 7 again, because the toothed portion 31 has an equal width, i.e., the area of the toothed portion 31 is a rectangular area, the engagement between the stop rod 30 and the ratchet wheel 20 is positive, and torsional force can be fully transmitted from the wrench body 10 to the ratchet wheel. 20 through the stop rod 30. Further, because the front side (the actuating face 32 of the stop rod 30 is a smoothly arched and the toothed portions 31 are bilaterally formed in the actuating face 32, the formation of the toothed portions 31 enhances the structural strength of the stop rod 30 without causing a concentration of stress.

FIG. 10 shows an alternate form of the stop rod 30. According to this alternate form, the stop rod 30 has a rectangular cross section.

A prototype of ratchet wrench has been constructed with the features of FIGS. 7-10. The ratchet wrench functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A ratchet wrench comprising:
a wrench body, said wrench body comprising a box disposed at one end thereof and defining a circular receiving open chamber, a transverse through hole in tangent to said circular receiving open chamber, an inside blind hole perpendicularly backwardly extended from said transverse through hole;
a ratchet wheel mounted in said circular receiving open chamber;
a spring member mounted in said inside blind hole;
a steel ball supported on said spring member; and
a stop rod mounted in said transverse through hole and supported on said steel ball at said spring member and adapted for controlling the direction of rotation of said ratchet wheel in said receiving open chamber;
wherein said stop rod has a smoothly arched front actuating face curved inwards in a rectangular front side thereof, and two toothed portions bilaterally formed in said smoothly arched front actuating face and adapted for engaging said ratchet wheel, said toothed portions having an equal width.

2. The ratchet wrench as claimed in claim 1 wherein said stop rod has a substantially U-shaped cross section.

3. The ratchet wrench as claimed in claim 1 wherein said
